(19) United States
(12) Patent Application Publication
(10) Pub. No.: US 2026/0220402 A1
(43) Pub. Date: Jul. 30, 2026

(54) Near Field Communication and Radio Frequency Identification Tags in Associated Combination

(71) Applicant: Zelus Wallet, LLC, Dallas, TX (US)

(72) Inventor: Kyle Thomas Mistele, Dallas, TX (US)

(21) Appl. No.: 19/424,109

(22) Filed: Dec. 17, 2025

Related U.S. Application Data
(60) Provisional application No. 63/735,246, filed on Dec. 17, 2024.

(51) Int. Cl. G06K 7/10

(52) U.S. Cl. CPC G06K 7/10297

(57) ABSTRACT

An NFC tag and an RFID tag are associated in combination. The resulting stacked tag is embedded in select physical items (clothing or other types of merchandise as desired). Users are provided with these tagged items by a given organization. A user scans the NFC tag in the corresponding tagged item, and the NFC tag is authorized and associated with the user. By extension the user is now associated with the corresponding RFID tag and the tagged item. The user may be prompted during this process to enter some information. As the user with the tagged item moves about, RFID readers read the RFID tag in the tagged item, and record desired information such as the user's movements and entities and/or people with which the user interacts.

### CROSS-REFERENCE TO RELATED APPLICATION

The present application claims the benefit under 35 U.S.C. § 119(e) of U.S. Provisional Patent Application Ser. No. 63/735,246, entitled “Near Field Communication (NFC) and RFID (Radio Frequency Identification) Stack,” filed on Dec. 17, 2024, and having the same assignee, the entire contents of which are incorporated herein by reference.

### TECHNICAL FIELD

This disclosure pertains generally to use of an NFC tag and an RFID tag in associated combination, and more specifically to using such a combination to glean different granularities of information concerning users, as the users come within the different read ranges of the associated NFC and RFID tags.

### BACKGROUND

A Radio Frequency Identification (RFID) tag is a small electronic device that consists of an antenna, and a small integrated circuit (IC) that includes a memory chip, which usually stores a tag ID, and can store additional data to be read by a reader. RFID tags may be passive tags that do not include a battery in the IC, or they may be battery powered although this is less common.

The data stored in an RFID tag's integrated circuit and memory chip can be read using an RFID tag reader, which captures the data via low-frequency, high-frequency, or ultra-high frequency (UHF) radio waves. When an RFID tag is read by the reader, the IC on the tag returns the data in the memory chip to the reader also using radio waves. In the case of battery-powered RFID tags, the tag may use its own power to respond to the reader, in which case it may be able to be read from a longer range. In the case of passive (non-battery-powered) tags, the radio waves from the reader electromagnetically induce a charge in the tag's IC that is used to perform any calculations, retrieve data from the memory chip of the IC, and reply with the requested data.

NFC Tags are a subset of RFID tags. They are read in the high-frequency RFID range, and generally can contain much more complicated circuitry that offers advanced functionality. For example, an NFC tag may be able to perform encryption logic, may have read/write memory that can be locked or password protected to prevent unauthorized reads/writes, can perform peer-to-peer communication, and can have a variety of different data fields that can be read or written individually from each other.

NFC tags are read via high-frequency radio waves that induce a charge in the tag and its antenna. Due to the more complex circuitry of an NFC tag, they can only be read at close range, typically a few centimeters, due to the necessity of inducing a stronger charge.

Unlike RFID tags, NFC tags can be read by contemporary smartphones. The NFC specification was originally designed with smartphones in mind for near-field communication (NFC). Contemporary smartphones may have a variety of features that allow for interaction with NFC tags. For example, scanning an NFC tag might cause the tag to reply with a URL (if the tag is programmed to do so) which the smartphone can then prompt the user to launch, or which it can launch automatically.

NFC Tags can be used for applications such as card emulation (Apple Wallet and Google Wallet both use NFCs to emulate credit cards for the “tap-to-pay” checkout method), user interaction and engagement, access control (e.g., “badges” that grant access to buildings), smart home automation and event ticketing.

NFC tags support more complicated functionalities than most RFID tags, but unlike non-NFC RFID tags can only be read at close range (typically several centimeters as noted above). Passive RFID tags can be read at longer range, often from multiple meters away. With specialized readers such as beam-steerable antennas, passive RFID tags can some cases be read at up to 18meters away. Powered (battery-powered) RFID tags can, in some cases, be read from up to 900+ meters away with specialized equipment.

NFC tags rely on the high-frequency subset of RFID frequencies, and typically do not support low-frequency or ultra-high frequency. Conventional smartphones can read and interact with NFC tags, but cannot read or interact with non-NFC RFID tags.

Thus, NFC tags and non-NFC RFID tags each have advantages and disadvantages. It would be desirable to address these issues.

### SUMMARY

An NFC tag and an RFID tag are associated in combination. The resulting stacked tag is embedded in select physical items (clothing or other types of merchandise as desired). Users are provided with these tagged items (via purchase, license, award, gift, etc.) by a given organization. A user scans the NFC tag in the corresponding tagged item using their smartphone, and the NFC tag is authorized and associated with the user. By extension the user is now associated with the corresponding RFID tag and the tagged item. The user may be prompted during this process to enter some information, in return for loyalty points or other incentives. As the user with the tagged item moves about, RFID readers read the RFID tag in the tagged item, and record desired information such as the user's movements and entities and/or people with which the user interacts. Because the read ranges of the NFC and RFID tags are different, different granularities of information can be gleaned and associated as users come within the different read ranges of the associated NFC and RFID tags.

The features and advantages described in this summary and in the following detailed description are not all-inclusive, and particularly, many additional features and advantages may be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 illustrates a network environment in which a stacked tag processing system can operate, according to some implementations.

FIG. 2 illustrates the operation of a stacked tag processing system, according to some implementations.

FIG. 3 illustrates a stacked tag, according to some implementations.

FIG. 4 illustrates the operation of a stacked tag processing system, according to other implementations.

FIG. 5 illustrates a computer system suitable for implementing a stacked tag processing system, according to some implementations.

The Figures depict various implementations for purposes of illustration only. One skilled in the art will readily recognize from the following discussion that other implementations of the structures and methods illustrated herein may be employed without departing from the principles described herein.

### DETAILED DESCRIPTION

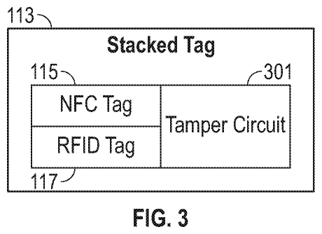

A stacked tag processing system 101 utilizes stacked tags 113 to enable organizations to interact with other parties in unique ways, as described in more detail below. As the term is used herein, a stacked tag 113 means a single physical device that includes both an NFC tag 115, and an RFID tag 117. The two tags need not be actually stacked, one on top of the other, but comprise a single physical form factor of any geometry in which the two tags are present. In some implementations, a stacked tag 113 may include more than one NFC tags 115 and/or RFID tags 117. As used herein, the term “RFID tag 117” means a non-NFC RFID tag (i.e., an RFID tag that is not in the form of an NFC tag 115). Architectures of stacked tags 113 and their components are discussed in more detail below in conjunction with FIG. 3.

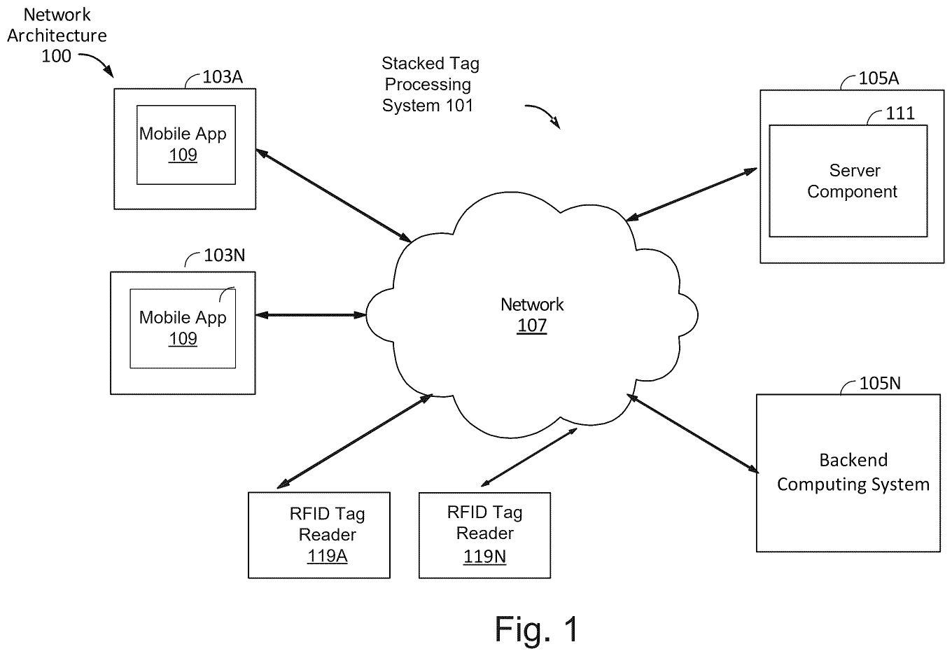

FIG. 1 is a high-level block diagram illustrating an exemplary network architecture 100 in which a stacked tag processing system 101 can be implemented. Referring to FIG. 1, the illustrated network architecture 100 comprises multiple mobile computing devices 103A and 103N (together may be referred to as “mobile computing device(s) 103” or “mobile device(s) 103”), RFID tag readers 119A and 109N (together may be referred to as “RFID tag reader(s) 119”), and server computer systems 105A and 105N (together may be referred to as “server(s) 105”). The illustrated number of mobile computing devices 103, RFID tag readers 119, and servers 105 is an example only. In some implementations, more (or fewer) of these various devices may be deployed, including orders of magnitude more, especially in the cases of mobile computing devices 103, and/or RFID tag readers 119.

In FIG. 1, a server component 111 of the stacked tag processing system 101 is illustrated as residing on server computer system 105A, with a mobile app 109 running on each mobile computing device 103A-N. Each mobile app 109 is an individual endpoint level component of the stacked tag processing system 101. It is to be understood that FIG. 1 illustrates an example implementation only. In various implementations, various functionalities of the stacked tag processing system 101 can be instantiated on a server computer system 105, a mobile computing device 103, another type of computer system 610, or can be distributed among multiple server computer systems 105, other types of computer systems 610, and/or mobile computing devices 103.

The mobile computing devices 103 can be in the form of mobile computing devices operated by users, comprising portable computer systems capable of connecting to a network 107 and running applications (e.g., smartphones, tablet computers, wearable computing devices such as smart watches/smart glasses, etc.). A user of a mobile computing device 103 can interact with a mobile app 109 residing on the specific mobile computing device 103 to engage in various activities as discussed in greater detail below. For example, a mobile app 109 may be an app that executes on an operating system for mobile devices, such as Android, iOS, WareOS, Sailfish, etc. A mobile app 109 can in communicate with the server component 111, in some cases without the user being aware of the underlying functionality being performed transparently by the stacked tag processing system 101.

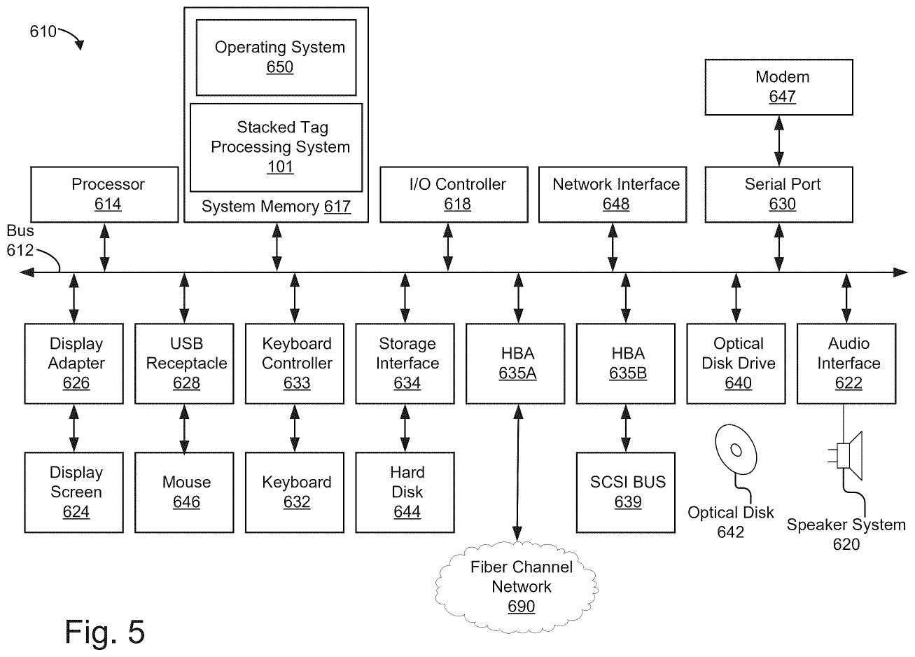

Mobile computing devices 103 and server computer systems 105 can be implemented using computer systems 610 such as the one illustrated in FIG. 5 and described below. The mobile computing devices 103, server computer systems 105, and RFID tag readers 119 are communicatively coupled to a network 107, for example via a network interface 248 as described below in conjunction with FIG. 5. In one implementation, the network 107 is in the form of the internet. Other networks 107 or network-based environments can be used in other implementations. Mobile computing devices 103 are able to access applications and/or data on server computer systems 105 using the mobile app 109 and/or, for example, a web browser or other mobile computing device software. Server computer systems 105 can be in the form of, e.g., rack-mounted computing devices, located, e.g., in data centers.

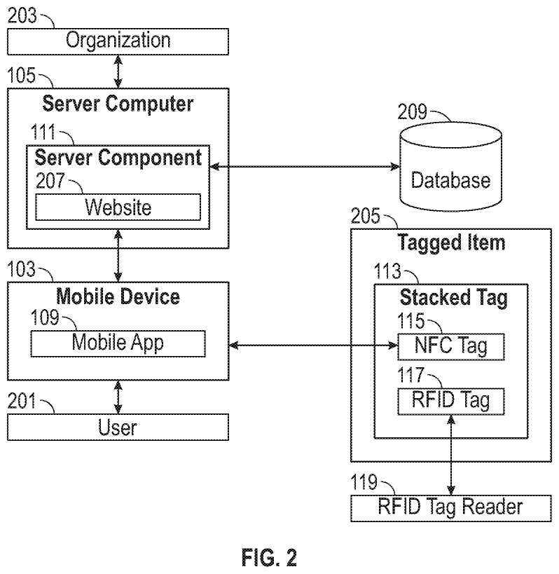

FIG. 2 illustrates the operation of a stacked tag processing system 101. As described above, the functionalities of the stacked tag processing system 101 can reside on a server computer system 105 and/or a mobile computing device 103, and/or be otherwise distributed between multiple computer systems 610, including within a cloud-based computing environment in which the functionality of the stacked tag processing system 101 is provided as a cloud-based service over a network 107. It is to be understood that although the stacked tag processing system 101 is illustrated in FIG. 2 as comprising a server component 111 and multiple mobile apps 109, the stacked tag processing system 101 represents a collection of functionalities, which can be instantiated as a single or as multiple entities and/or modules, as desired. In some implementations, the different components of the stacked tag processing system 101 can reside on different computing devices 610 as desired. The server component 111 can be implemented as one or more applications configured to run on the server computer system 105. Each mobile app 109 can be instantiated as an app for a given mobile operating system as noted above, with different mobile apps 109 being specifically implemented for different types of operating environments utilized by different users.

It is to be understood that the components and modules of the stacked tag processing system 101 can be instantiated (for example as object code or executable images) within the system memory 617 (e.g., RAM, ROM, flash memory) of any computer system 610, such that when the processor 614 of the computer system 610 processes a module, the computer system 610 executes the associated functionality. As used herein, the terms “computer system,” “computer,” “server computer system,” “mobile computing device,” “client,” “client computer,” “server,” “server computer” and “computing device” mean one or more computers configured and/or programmed to execute the described functionality. Additionally, program code to implement the functionalities of the stacked tag processing system 101 can be stored on computer-readable storage media. Any form of tangible computer-readable storage medium can be used in this context, such as magnetic, optical, flash and/or solid-state storage media, or any other type of media. As used herein, the term “computer-readable storage medium” does not mean an electrical signal separate from an underlying physical medium.

As illustrated in FIG. 2, the stacked tag processing system 101 automatically utilizes stacked tags 113, RFID tag readers 109 deployed in the field, and NFC tag reading functionality on user's mobile computing devices 103 to identify user's interaction with merchandise or other items containing stacked tags 113, as well as the behavior of the users 201 in a broader environment beyond the range in which NFC tags 115 can be read.

In FIG. 2, a specific user 201 is illustrated operating the mobile app 109 on a mobile computing device 103 (for example, the user's smartphone). The functionality provided by the stacked tag processing system 101 enables organizations 203 to interact with and glean information concerning their customers (e.g., the example user 201 illustrated in FIG. 2) at multiple levels of granularity. An organization 203 can be in the form of a corporation, brand, store, producer of a music festival or sporting event, an educational institution, or even an individual or group seeking to provide users 201 with the functionality and obtain the benefits of the stacked tag processing system 101 described herein.

In this context, stacked tags 113 may be embedded in or otherwise attached to items provided (e.g., sold, leased, loaned, awarded, etc.) to users 201 by organizations 203. The term “tagged item 205” is used herein to refer to an item provided to users 201 to/in which a stacked tag 213 has been attached/embedded or otherwise conjoined. Some examples of items which can be so tagged are clothing, purses, bags, reusable drink containers, jewelry, etc.

Users 102 (i.e., those parties who purchased or otherwise legitimately obtained the tagged item 205) can scan the NFC tag 115 of the stacked tag 113 in the tagged item 205 with their mobile computing device 103 (e.g., smartphone), using the mobile app 109 of the stacked tag processing system 101 and the NFC tag reading functionality of the mobile computing device 103. An organization 203 can incent users 201 to scan the NFC tag 115 by providing access to any of a number of different types of content or benefits that are of value to the user 201. Some non-exhaustive examples are exclusive digital media, loyalty programs through which users 201 can obtain rewards such as points, functionality through which the user can add the tagged item 205 to a digital collection for use in a loyalty program, social media, or other purposes, rewards for purchasing the item, offers of future discounts on other items, etc.

The mobile app 109 reading the NFC tag 115 of the stacked tag 113 results in the NFC tag 115 generating a Uniform Resource Locator (URL) pointing to a website 207 (or other form of backend interface) provided by the server component 111 of the stacked tag processing system 101. The default browser on mobile device 109 can follow the URL, and the website 207 prompts the user 201 to enter data, such as their email address (e.g., to create an account) and possibly other biographic information such as name, phone number, etc. The specific data which the user 201 is prompted to enter is a variable design parameter based on the preferences of the organization 203. For example, the user may be prompted to snap a selfie and upload that, from which the stacked tag processing system 101 can extract other biographical information. In some implementations, the stacked tag processing system 101 also gleans additional data from the user's mobile device itself depending upon permission settings. Thus, the user 201 scanning an NFC tag 115 as described above provides a way for an organization 203 to obtain certain data concerning the user 201, based on what the user 201 enters and/or what can be gleaned from the mobile device 109. From this process, at least the identity of the user 201 and an association between the user and the specific tagged item 205 is established. The user can be identified by email address, name, phone number, a unique identification number associated with the user's mobile computing device 109, or other criteria. Because the user 201 has scanned the NFC tag 115 of the stacked tag 113 associated with the tagged item 205, an association between the specific user 201 and the specific tagged item is established.

In some implementations, when the user 201 scans the NFC tag 115 of the stacked tag 113 with their smartphone, the stacked tag processing system 101 authenticates the scanned tag, using parameters in the URL generated by the tag, and thus, for example, authenticates the user 201 is being in legitimate possession of the tagged item 205. As described above, the NFC tag 115 in the stacked tag 113 can be scanned with the mobile 109 on the user's smartphone. When the NFC tag 115 is scanned, the mobile app 109 displays a popup or other graphical user interface (GUI) element that allows the user to follow a URL generated by the NFC tag 115.

As described in more detail below, following the URL identifies the NFC tag 115 to the stacked tag processing system 101, and can be used by the stacked tag processing system 101 to authenticate the NFC tag 115. In some implementations, this can be used to ensure that this is a new, unique scan, such that the URL generated by the scan of the tagged item 205 cannot be re-used, so that the user 201 can not be credited for purchasing the same tagged item 205 more than once, and so that multiple users 201 cannot be associated with the same tagged item 205, etc. In other words, the NFC tag 113 can authenticates ownership of the tagged item 205 by the user 201, because the NFC tag 113 is authenticable and unique For example, in one implementation when the stacked tag processing system 101 authenticates the NFC tag 115, the stacked tag processing system 101 can check the database 209 (described in detail below), and determine whether the scanned NFC tag ID is actually in the database 209 (i.e., whether it is a legitimate NFC tag 113 that is part of a legitimate stacked tag 113), and/or whether the associated tagged item 205 is already associated with given a user 201. If so, it can return an error message which can be displayed to the user 201 that just scanned the tagged item 205 via their mobile device 109. On the other hand, if the NFC tag 113 is legitimate and/or the scanned tagged item 205 is not yet associated with a user 201 in the database 209, the stacked tag processing system 101 can proceed to redirect the user 201 to the website 207 and proceed to collect the user's identity and other information as described above. Authentication according to various implementations is discussed in more detail below in conjunction with FIG. 3.

The server component 111 of the stacked tag processing system 101 maintains a database 209 (or other suitable storage mechanism) which contains identifiers (IDs) of each one of the stacked tags 113 used by the organization 203. The database entries for given stacked tags 113 contain the IDs of both the NFC tag 115 and RFID tag 117 of the given stacked tag 113. As described above, the server component 111 of the stacked tag processing system 101 identifies the user 201 and collects user entered data via the website 207 when a user 201 scans the NFC tag 115 of the stacked tag 113 in a given tagged item 205. Using the NFC tag ID, the server component 111 of the stacked tag processing system 101 can access the database entry associated with the given stacked tag 113, and add the user ID and any collected information concerning the user 201 to the entry. Thus, server component 111 now has a record of which user 201 has possession of the given tagged item 205. It is to be understood that the server component 111 maintains and secures the database 209, and can look up entries according to various criteria such as the ID of the NFC tag 115 or the ID of the RFID tag 117 of a given stacked tag 113, or the user ID. Parties without access to the secured database 209 cannot obtain any information from the database 209 (e.g., concerning the user 201 or the tagged item 205) simply by scanning either the NFC tag 115 or the RFID tag 117 and learning their respective IDs.

It is to be understood that the specific instantiation of the database 209 (or other storage mechanism) can vary between implementations. For example, in one example implementation the database 209 stores a list of NFC tags 115, and a list of RFID tags 117, with a mapping of each NFC tag 115 to the RFID tag 117 with which it is stacked, such that given the ID of a scanned NFC tag 115, the stacked tag processing system 101 (and by extension the organization 203 with access to the database 209) can look up the corresponding RFID tag 117, or vice versa, and by extension the ID of the given user 201 in possession of the associated stacked item 205, and any stored data concerning that specific user 201. Because the stacked tag processing system 101 can resolve an NFC tag ID or the RFID tag ID to the user's ID through the linkage in the database 209, the organization 203 can automatically collect certain information about the user 201 that would be unavailable through a traditional retail transaction, such as tracking how many of a given item or how many different items from the organization 203 a given user has purchased.

Despite this, reading and processing the NFC tag 115 by itself does not enable the organization 203 to obtain any information concerning the actions of the user 201, other than their association with the tagged item 205 and corresponding purchase. Organizations 203 are increasingly interested in gleaning data concerning with whom and/or what their customers (the users 201) are interacting, how they are interacting with such people/things, what types of customers are doing what types of interactions, the contexts of the interactions, etc.

For example, suppose a given organization 203 is a producer of a music festival or other live event. Users 201 may buy tagged items 205 at the music festival, such as band shirts and the like. Through the user's scanning of the NFC tags 117 in the tagged items 205 and the entering of data as described above, the organization 203 has access to some information about the users 201 who buy the tagged items 205, but without more does not have access to information concerning what types of things the users 201 are doing at the live event, with what or whom they are interacting with at the live event (e.g., specific branded booths at the event, specific photo backdrops, or any of a dozen other things), etc.

To give another example, suppose the organization 203 is a luxury fashion brand. Such an organization could tag their merchandise with stacked tags 113. When a user 201 buys, e.g., a tagged handbag 205, the user 201 could scan the NFC tag 115 using their phone, and thereby authenticate the purchased tagged item 205, add it to their digital collection of merchandise purchased from the given luxury brand, and obtain some loyalty rewards as described above. The organization 203 (the luxury fashion brand) would learn that the given user 201 purchased the given tagged item 205 (the bag), but would be unable to benefit from being able to collect behavioral data about the user 201 beyond what can be gleaned from the scan of the NFC tag 115.

For example, the luxury fashion brand might want to be able to automatically determine when valued customers enter an associated retail establishment or other location to be able to offer customized experiences, such as greeting them by name and providing a glass of champagne or the like. Because of the read-range limitations of NFC tag scanning technology, scanning an NFC tag 115 by itself does not enable this type of functionality.

To address this, the RFID tag 117 of the stacked tag 113 is utilized. Because the database 209 stores information about stacked tags 113, once an NFC tag 115 is scanned, validated, and associated with a given user 201, the stacked tag processing system 101 can also collect data about the behavior of that user 201 via the RFID tag 117 of the stacked tag 113. To do so, one or more ultra-high-frequency RFID tag reader(s) 109 are strategically placed within a physical space of interest to and/or under the control of the organization 203, such as for example a music festival, a conference, a convention, a store, a sporting event, etc. The placement of the RFID tag readers 109 can be at different locations at which the organization 203 wants to track user interaction, such as proximate foot traffic, time spent, and/or other metrics.

More specifically, the organization can place a desired number ultra-high-frequency RFID readers 109 within RFID tag reading range of locations where the organization would like to scan RFID tags 117 and hence detect and track activities by the users 201 in possession of tagged items 205. This can be, for example, within RFID scanning range of the entrances to the organization's stores or other physical locations, at booths in a conference or convention, proximate to stages or merchandising areas at live events, and so forth. RFID tag readers 109 with varying degrees of sensitivity can be strategically placed as desired, such as placing relatively less expensive shorter-range readers 109 at individual booths at a conference, or placing relatively more expensive longer-range readers 109 by the stage at a concert, etc.

In other words, each RFID tag reader's location placement can be selected so that the data it collects is geographically grounded. The range of the reader 119 can thus be calibrated appropriately for the placement and use case. For the conference example, RFID tag readers 109 with a range of about 1-2 meters could be desirable, whereas for a music festival, RFID tag readers 109 with a range of a dozen or more meters may be appropriate. The specific range and placement combinations of the RFID tag reads 109 are a variable design parameter which can be adjusted based on the specific implementation and use case.

Once the RFID tag readers 109 are activated, the antennas of an RFID tag readers 109 read the RFID tags 117 of stacked tags 113 in tagged items 205 worn, held by, or otherwise coupled to users 201 when they come in range. When an RFID reader reads an RFID tag 117 of a tagged item 205, it can record the identifier (ID) of the RFID tag 117. Thus, as users 201 with tagged items 205 move around, the RFID tag readers 109 glean the corresponding RFID tag IDs.

Each RFID tag reader 109 can transmit tag read data such as the IDs of the RFID tags 117 and any related telemetry such as time of the scan, location of the scan and hence inferred physical location of the user 201, etc., to the stacked tag processing system 101. In one implementation, RFID tag readers 109 are online, and transmit their collected tag read information to the stacked tag processing system 101 in real-time. In another implementation, one or more RFID tag readers 109 may be offline, in which case they can store scanned data for later collection, aggregation and analysis by the stacked tag processing system 101.

Using the database 209, the stacked tag processing system 101 can resolve the IDs of the RFID tags 117 scanned by each RFID reader 109 to the IDs of the NFC tags 115 with which they are stacked, and by extension to the ID of the associated user and any biographical, contact, and/or other demographic information concerning the user 201 that was collected through user interaction with the NFC tag 115. Through this process, organizations 203 can obtain high-resolution behavioral data about different users 201 and groups of users 201, for example by demographic. The use of the stacked tag processing system 101 as described above enables the collection and utilization of multi-dimensional data collected in association with both an NFC tag 115 and a corresponding RFID tag 117, because the stacked tag 113 has a single physical form-factor that includes both.

For example, the luxury fashion brand described can incent purchasers of handbags or other tagged items 205 to scan the NFC tags 115 with their mobile apps 109 and enter user information as described above. The stacked tag processing system 101 gleans and authenticates the NFC tag ID, and associates it with the user 201. Then, one or more RFID tag reader(s) 109 could be deployed at, e.g., entrances to retail locations or other desired locations. The RFID tag reader(s) 109 detect(s) RFID tags 117 that come within range, and transmits the tag read data to the stacked tag processing system 101. Tag read data is processed, and for reads of RFID tags 117 in tagged items 113, the information associated with the user 201 in the associated database entry can be made available to the organization 203 in real time (e.g., a manager or the like could view output from the stacked tag processing system 101 in real time on a computing device).

Thus, for example, when a user bearing a tagged item 205 approaches the counter in one of the brand's stores, the stacked tag processing system 101 detects this via the RFID tag read, performs a subsequent database lookup, and transmits a notifications to the store manager or other relevant party. The manager could then greet the user 201 by name or otherwise offer them a highly personalized experience based on the information that is available to them as a result of being able to resolve the RFID tag's ID to data concerning the user 201, collected via the NFC tag 115 as described above. The stacked tag processing system 101 can push the notification to a person (e.g., via a transmission to a computing device resulting in a notification that a person will perceive). The stacked tag processing system 101 can also transmit a notification meant to be automatically processed by a computer of the organization 203, instructing, for example, to automatically offer a given discount or take other automatic action concerning the user 201. In either case, any stored information concerning the user 103 can be retrieved, including engagement information collected by the stacked tag processing system 101 up to that point, e.g., time of last visit/tag scan, the user's preferences, etc.

For live events, data gleaned via the RFID tag readers 109 and correlated with other information in the database 209 could be used in a variety of ways, such as to contact of users 201 that interacted with a given vendor, to build a heatmap of the event/venue to identify popular activities and engagement points, to map traffic flows, or any other use of data that could be collected via the stacked tag processing system 101.

In general, using the multi-dimensional information gleaned by the stacked tag processing system 101, organizations 201 can analyze which end-users 201 were present at or interacted with certain locations, when they did so, how they interacted, etc., enabling the organization 203 to build an individualized non-anonymous activity profile for each user 201. Organizations 203 can also analyze data in aggregate to understand preferences, behaviors, and common activities for all users 201, or groups of users by collected demographic information at any level of granularity.

Turning now to FIG. 3, example stacked tag 113 architectures are described according to some implementations. As noted above, the stacked tag processing system 101 provides stacked tags 113 that includes both an NFC tag 115, and an UHF RFID tag 117. Each stacked tag 113 itself as well as each of its components all have a unique ID. In other words, each stacked tag 113 has a unique ID, as do its component NFC tag 115 and RFID tag 117. The NFC tag 117 (e.g., an NTAG424) can be programmed to return a followable URL to the mobile device 103 (e.g., smartphone) used to scan it. The URL generated by the NFC tag and returned to the smartphone may contain multiple parameters that allows the stacked tag processing system 101 to perform functionalities such as identify the tag, authenticate that the tag as real, prevent re-use of the returned URL, optionally detect the state of a tamper circuit 301 that trips when the stacked tag 113 or the corresponding tagged item 205 has been tampered with (e.g., to indicate if a box which the stacked tag 112 is attached to has been opened, if a bottle of wine to which a stacked tag 113 is attached has been uncorked, etc.). Each RFID tag's unique ID may be unencrypted such that it is readable by any reader, or it may be encrypted such that only readers 109 which are authenticated for use with the stacked tag processing system 101 can decrypt the tag's ID and read it. In either case, the RFID tag's ID by itself is anonymized and contains no user information.

A stacked tag 113 may be embedded in merchandise, tickets, items of clothing, and various other form-factors. It is typically small, thin, and insertable into a wide variety of mediums. An organization 203 can embed stacked tags in their merchandise, clothing, or other items. Stacked tags 113 can use a tamper tag form factor, according to which there is an additional (e.g., longer) tamper circuit 301 that is linked to the stacked tag 113, for example by being placed behind a seam, a seal, or elsewhere. The status of this tamper circuit 301 is readable by the stacked tag 113, and its status can be read and authenticated, for example, via scans of the NFC tag 115 when the URL returned from the tag scan is followed to the stacked tag processing system 101. This can be used to allow the stacked tag processing system 101 to verify if the item that the stacked tag 113 is attached to has been altered in a given way that renders the stacked tag 113 invalid. The tamper circuit 301 can be included in the stacked tag 113 in such a way that is conducive to detecting a given form of tampering. For example, the stacked tag 113 may include an adhesive component such that attempting to remove the stacked tag 113 from the item it is embedded in will permanently damage or destroy the tamper circuit 301, preventing the tag from being used if it is removed from its intended location. This same objective may also be achieved by other form-factor modifications, including “stitching” a tamper circuit 301 into the material (e.g., leather) or in other ways as desired.

In some implementations an NTAG424 is used as the NFC tag 115, which uses the following to provide secure authentication: AWS-128 symmetric cryptography, cryptographically-secure access permissions, and SUN (Secure Unique NFC) authentication.

The RFID tag 117 of the stacked tag typically uses a different frequency than the NFC tag 115. In some implementations 13.56 MHz UHF (ultra-high-frequency) RFID tags 117 are used since they can be read at long distance with a relatively low power consumption. In one implementation the system uses an NFC tag 115 and a paired RFID 117 that are in different locations or form-factors, but otherwise the functionality remains the same as described above.

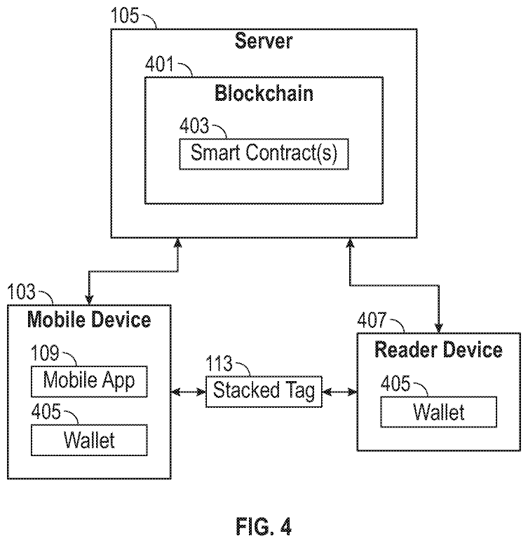

Turning to FIG. 4, other implementations are described in which a blockchain 401 is used for additional authentication of the NFC tag 115. In these implementations, an NFC tag 115 can be authenticated using the blockchain 401 and asymmetric-key cryptography (e.g., RSA, Elliptic Curve Cryptography, etc.), instead of (or in addition to) the authentication process utilizing the server component 111 of the stacked tag processing system 101 as described above in conjunction with FIGS. 2 and 3. In FIG. 4 the blockchain is illustrated as being on a specific server 105 although blockchains 401 are distributed as described in more detail below.

The NFC tag 113 can be authenticated using the blockchain 401 in different ways. In some implementations, user data may be stored on the blockchain 401, whereas in other implementations using blockchain based authentication this is avoided for security reasons. In one implementation, each NFC tag 115 used in a stacked tag 113 has a private key securely stored in write/execute-only memory or is otherwise password protected. In one such implementation, a separate blockchain smart contract 403 is associated with each given NFC tag 115, and each such smart contract 403 stores a public key that corresponds to the associated NFC tag's private key.

The NFC tag's integrated circuit (IC) is capable of generating a cryptographic signature of an internally-generated counter value or “number used once” (nonce) value. A nonce is a unique, arbitrary number or string used only once in a cryptographic communication or protocol, ensuring security by making each transaction or message distinct. A nonce may include timestamps or high randomness for uniqueness, and for preventing attackers from reusing old valid data. Scanning the NFC tag 115 by the smartphone results in such a counter or nonce value being generated, a cryptographic signature of the counter/nonce value being calculated using the NFC tag's private key, and the cryptographic signature of the counter/nonce value being returned to the mobile device 103 (e.g., the mobile app 109 on the smartphone). The specific cryptographic signature scheme used may be any one of a number of asymmetric cryptographic signature schemes, and can vary between implementations as desired.

In some implementations, the mobile app 109 has access to blockchain cryptocurrency wallet 405 on the mobile device 103. The mobile app 109 can use the blockchain cryptocurrency wallet 405 to initiate a blockchain transaction against the smart contract 403 corresponding to the scanned NFC tag 115, providing the nonce or counter, and the cryptographic signature of the NFC tag 115. The smart contract 403 executes and performs the authentication transaction as described in detail below, and the mobile app 109 receives the result of the authentication transaction (e.g., whether the authentication was valid or not). The result of the authentication transaction may be returned as a return value from the call to the smart contract 403 on blockchains 401 that support this (e.g., some non-Ethereum Virtual Machine (EVM) based blockchains 401). In the case of Ethereum or other blockchains 401 that do not support this, the result of the authentication transaction may be emitted as an on-chain event, which is readable by the mobile app 109.

In different implementations, to submit a transaction to a blockchain 401 the mobile app 109 may run a full blockchain Remote Procedure Call “RPC” node, use a “light client” node for the blockchain 401 in question, or use a third-party RPC API service to submit blockchain transactions to the blockchain 401. An RPC node is in the form of a server 105 that acts as a bridge, letting wallets 405, decentralized applications, and users communicate with the blockchain 401, read data, and submit transactions without running a full node themselves. THE RPC node translates app requests into the blockchain's language (e.g., JSON-RPC), sends them to the blockchain network, and returns the blockchain's response. A light client node is resource-efficient blockchain software that does not download the entire blockchain 401, but connects to full nodes and downloads only specific data such as block headers, and uses cryptographic proofs to verify transactions.

As noted above, when the smart contract 403 executes it can verify the signature and ensure the nonce value has not been used before or that the counter is correct. Then, once it has been determined the signature is valid and the counter is correct/that the nonce value has not been seen before, the smart contract 403 can store the nonce value or increment the counter internally, so that the same signature cannot be used again, before returning a success response. As noted above, authentication success/failure responses may be returned as a return value of the function where supported by the blockchain 401, or may be emitted as a blockchain event. In other implementations, other ways of signaling a successful or failed authentication may be used.

In some implementations, a single smart contract 403 stores n public keys for n different NFC tags 115, such that the single smart contract 403 can be used to authenticate each NFC tag 115. In this case, the authentication function on the smart contract 403 that is called as a part of authentication transaction (or contract call) receives the counter or nonce value provided by the scan of the specific NFC tag 115, the cryptographic signature generated by that NFC tag 115, and/or the NFC tag ID, so that the smart contract 403 can look up the correct public key from its internal storage to verify and authenticate the cryptographic signature.

Execution of a blockchain 401 transaction typically utilizes a cryptocurrency wallet 405 for the blockchain 401 in question (e.g., Ethereum, Bitcoin, etc.), usually with a balance in the currency for the given blockchain 401, to pay for the “gas” or transaction fee for submitting a transaction for on-chain execution. In different implementations, payment of the gas fee for the transaction to authenticate an NFC tag 113 is managed in different ways. Where the mobile device 103 (e.g., smartphone) is used as the authentication device, the NFC URL protocol described above can be used to induce cryptocurrency wallet application functionality by the mobile app 109 on the mobile device 103 to execute the transaction using a custom URI scheme (e.g., metamask→metamask:// as opposed to https://) for a cryptocurrency wallet 405 known to the mobile app 109. In this scenario, the NFC tag 115 is coded to return a URL to call or launch the mobile app 109. In this implementation, the mobile app 109 supports allowing a transaction to be proposed to it via an application-specific custom URI schema that is supported by the mobile app 109 on all underlying supported operating systems (e.g., both iOS and Android). The transaction proposed to the mobile app 109 includes information about the smart contract address, blockchain ID and blockchain type. The mobile app 109 may support this functionality via, for example, walletconnect deep-linking.

In another implementation, the mobile device 103 uses a type of protocol specifier akin to https:// which, instead of opening the default web browser on the mobile device 103 opens the default cryptocurrency wallet/authentication app on the device 103, which in this case is set to the mobile app 109. In this scenario, the NFC tag generates a URL that uses a new protocol specifier handled by a device-or-user-determined “default cryptocurrency wallet app (the mobile app 109),” akin to how HTTP/HTTPS links on-device are handled by the device's default web browser. For this scenario, conventional smartphones do not typically support a generic, nonapplication-specific, non-HTTP/HTTPS protocol specifier for cryptocurrency wallets 405 by default, so the customization is performed at the mobile app 109 level.

In another implementation, the authentication device is not the mobile device 103, but instead a purpose-built reader device 407 for integration with the stacked tag processing system 101. Instead of using the NFC URI protocol, the raw signature and other transaction information can be returned directly to the reader device 407. In this implementation, the reader device 407 may either access a full RPC node, light client, or other RPC service that it can use to generate and submit a verification transaction to the smart contract 403. In this implementation, the reader device 407 has access to a cryptocurrency wallet 405 on-device, or on a centralized service which multiple properly-configured and authenticated reader devices 407 can share.

In the above described implementations, the wallet 405 typically has a balance of the cryptocurrency for the blockchain 401 in question sufficient to pay the gas fee for each authentication operation it initiates. This is not a hard limitation however, as it is possible to relay transactions on-chain without gas-fees paid by the sender. For example, if the transaction is sponsored by a third party such as the organization 203 (via, e.g., ERC-4337 Account Abstraction) the wallet 405 can access an associated RPC URL for a trusted blockchain node or service.

Any of the described above implementations can be modified so that a blockchain call operation is used to authenticate instead of a transaction. In these scenarios, no gas/transaction fee is required. However, the reason that call operations are gasless is that they do not update the blockchain's state; such a call is essentially a read-only operation. Therefore, re-use attacks are a concern, as nonces/counters in such cases would not typically be globally and securely tracked and invalidated after use. This may be acceptable for some applications, but not others, depending on the security requirements of the system (e.g., if it has other mechanisms to prevent untrusted actors from scanning the NFC tag 115, or if it has other ways of preventing replay attacks).

Different functionalities can be used in order for the mobile device 103 or reader device 407 to be aware of which blockchain 401 and smart contract 403 to transact with or call. In some implementations, the scanning and authenticating device(s) know or make an assumption at a software, firmware and/or hardware level about which smart contract 403 and blockchain 401 to transact against. For some cases or applications this may be sufficient. Where a purpose-built reader device 407 is used as described above, the reader device 407 can be configured to know or assume some or all of this information. Where the mobile app 109 on the mobile device 103 is used and known ahead of time, the mobile app 109 can be configured to store the blockchain 401 and smart contract information on a per-tag basis, to assume or know part or all of this information for all valid NFC tags 115, or for it to be able to consult a third party to learn this information (e.g., the server component 111, the manufacturer of the tags, etc.). In some cases, the information is provided to the mobile app 109 or other application initiating the verification transaction or contract call. These methodologies work in scenarios in which different NFC tags 115 have different associated smart contracts 403, and/or those smart contracts 403 are stored on and executed by different blockchains 401.

In other cases, including where a single smart contract 403 is in use for all NFC tags 115, each NFC tag 115 itself can provide identifying information of the blockchain 401 that the authentication smart contract 403 is stored on and executed by, and provide identifying information for the authenticating smart contract 403 (usually this is a contract address). The identifying information might be in the form of a “family of chains” (chain type), and a specific chain ID (e.g., “Cosmos” and a chain ID, or “EVM” and the Ethereum network's ID (e.g., “1”), or “Solana” and the Solana network's ID, etc.). The structure of this information may change depending on the blockchain 401 in question. So long as the NFC tag provides sufficient information to the mobile app 109 (or other cryptocurrency wallet application or authentication app), the mobile app 109 can identify the correct blockchain network to which to submit transactions or smart contract calls. In the case of URI-scheme-related approaches, this information may be in route parameters or query parameters of the URI, which may be read by the application that the URI scheme identifies and launches when used (e.g., the mobile app 109). For non-URI-scheme approaches where the data may be returned from the NFC tag 115 to a purpose-built reader device 407, the data may be returned or readable back to the reader device 407 in any NFC-tag-compliant format and protocol that the reader device 407 is able to parse and understand.

As noted above, Ethereum-based blockchains 401 do not typically support return of a “return value” from a smart contract 403 to the party that sends a transaction which executes a function on a smart contract, since EVM currently works such that the transaction is first mined and included in a block. Therefore, for schemes that involve the authenticating party/device sending a transaction to authenticate the NFC tag using Ethereum-based blockchains 401, typically the authenticating smart contract 403 emits an event, which can be queried on-chain by the authenticating party/device to determine the status of the authentication transaction/authenticity of the NFC tag, once the authenticating transaction has been executed, included in a block, and received an appropriate number of subsequent confirmations to be considered final. The authentication may be considered final when the requisite number of confirmations to guarantee “finality” are received. That request number may be a configuration that is particular to the blockchain network in question or the given implementation.

On some non-Ethereum-based blockchains 401, it is possible for the party that sends a transaction which executes a function on a smart contract 403 to receive a “return value” from the function without the usage of an event. In this case, this is an acceptable and secure means for the authenticating party/device to determine the status of the authentication transaction and therefore the authenticity of the NFC tag 115 in question.

For schemes that involve a smart contract 403 call rather than a transaction, Ethereum-based blockchains 401 typically allow the function to return a value directly. Therefore, the called function's return value can be used to indicate the authenticity of the NFC tag.

Note that various blockchain 401 architectures and networks may have different fundamental primitives-for example, the specific mechanism used to receive a return value from an executed function on a smart contract 403 may be a “return value” from the function, or it may be an “event” or a “log” or some other mechanism specific to the blockchain 401 in question; blockchain 401 architectures typically have some analogous ability that allows the authenticating party/device to read the result of a transaction, and different such features are used in different implementations.

One approach to tracking ownership of NFC tags/tagged items on-chain is via the authentication transaction that is initiated by the authenticating party/device through tag scan, In this implementation, the authentication smart contract 403 for the NFC tag includes a registry (or similar structure) of owners or of owner history. The implementation of this registry may vary, but typically entails some internal database or similar storage feature (e.g., contract state such as an array or map) indicating which NFC tag is owned by which wallet address. When ownership is changed, the state of this internal database will be updated to reflect the new owner. In some instances, an event or log is emitted from the smart contract 403 when the ownership is changed (e.g., indicating “tag” X was transferred from Alice to Bob), such that historical ownership can be tracked by querying and filtering/searching through event logs from past transactions. By traversing the event log (which can be conceptualized as, e.g., a singly-linked-list, it is possible to reconstruct the entire ownership history. If being able to query the point-in-time owner is not desired, such a chain of events could be used instead of the contract's internal state or database.

In another implementation, the current state (current ownership on a per-tag basis) in addition to the past states is tracked entirely in storage. In this case, logs/events could be omitted, although may still be desirable for the purposes of chain indexing and tracking.

One approach for this is to implement an ERC-721—compatible interface for token transfers, such that each non-fungible-token represents a single NFC tag. When the tag is authenticated or claimed, the non-fungible token corresponding to the tag would be transferred to the authenticating/claiming party. This provides a common standard interface for tracking current ownership as well as ownership history.

Other non-fungible token standards, semi-fungible token standards, or fungibility-agnostic standards (e.g., ERC-1155) may be used, for example in a scenario where multiple NFC tags share a private/public asymmetric key pair.

It is to be understood generally that a blockchain 401 can be used both to safely store data, and to conduct secure transactions. A blockchain 401 is a growing list of data records, known as blocks, which are linked together using cryptography. Each block contains a cryptographic hash of the previous block, and may contain a timestamp and transaction data. The timestamp proves that the transaction data existed when the block was added to the blockchain 401. As blocks in the chain each contain a cryptographic hash of the previous block, a blockchain 401 is resistant to modification, because no block can be modified after it is added to the chain without altering all subsequent blocks. The nature of this cryptographic linking of the blocks provides a high level of security, especially if there are a large number of blocks.

A blockchain 401 is distributed across a peer-to-peer network. Blockchains 401 are managed by a given protocol to communicate and validate new blocks. A consensus algorithm is used that allows the participating nodes to agree on information included within each new block. Using the consensus algorithm, the blockchain 401 is replicated and maintains the same state across the network of participants, allowing the blockchain 401 to function as a secure, decentralized, append-only ledger. Examples of consensus algorithms that can be used in this capacity include proof-of-work, proof-of-stake, proof-of-activity, proof-of-burn, proof-of-capacity, or proof-of-elapsed time. Different blockchains 401 utilize different formats, protocols, networks, etc. Some examples of blockchains 401 include Bitcoin, Ethereum, FLOW, Tezos, etc.

A blockchain 401 can be used as a ledger for transactions using a specific corresponding digital currency, with the blocks documenting one or more transactions that involve the transfer of the corresponding currency from one party to another. In some implementations, the currency is created as a reward for a process called mining, which is successful use of the consensus protocol to solve a computational problem and thereby validate a new block that is added to the chain. This is known as a proof of work consensus protocol. In other implementations, different proof of consensus protocols are used, such as proof of stake in which nodes compete to append blocks and earn associated rewards in proportion to stake, or existing cryptocurrency allocated and locked or staked for some time period. Other consensus protocols include proof of authority, proof of space, proof of burn, or proof of elapsed time. Different consensus protocols may be used in conjunction with different implementations of the stacked tag processing system 101 as desired.

Digital currency is registered to a specific address (public key). Once created and awarded to a miner (or other party as appropriate in implementations using different consensus protocols), the currency can be transferred to another party, using the public key of the receiving party as an address and the private key of the transferring party to sign the transaction. Owners of units of digital currency can subsequently use it in further transactions. Each transaction is broadcast to the peer-to-peer network, and once validated it is added to a new block in the chain, created through the process of mining (or other method) using the consensus protocol. To prevent double spending, each transfer must refer to a previous unspent receipt of the currency in the blockchain 401.

At the most fundamental level, a blockchain transaction is a cryptographically signed set of instructions from an account. When a user creates and signs a transaction, they send it to a node in the blockchain's network (e.g., the Ethereum network or the Flow network). The node will broadcast a request for a transaction to be executed, and, in a proof of work implementation, a miner on the network (e.g., an Ethereum miner) will execute the transaction and share the results with the rest of the blockchain's network. In other implementations, other consensus protocols are used such as proof of stake as described above.

There is typically a gas fee for each transaction. The gas fee is the price that a miner charges to execute a transaction. Gas fees may vary widely based on the current volume of transactions, the number of available miners, and the amount of data in the transaction. Gas fees are usually relatively small compared to the transaction size.

Most blockchains 401 support transactions through RPC (Remote Procedure Call) to a node on the blockchain's network. A user who wishes to make a transaction on the network structures the transaction data into the format specified by the blockchain's standard, and submits it as an RPC to a node on the network.

Digital signatures, also known as cryptographic signatures, are method of providing message integrity and message authentication for a given message using the properties of public-key cryptography. Once a digital signature is created for a message, the signature can be used to verify the message's integrity and sender.

A digital signature provides message integrity. Let us assume that a message is created by Alice, and is signed using Alice's private key. If some third party, Trudy, attempts to intercept and change the contents of the message, when the recipient Bob attempts to verify the signature, the verification process will indicate that the message has been altered and that Bob should discard the message.

A digital signature provides message authentication. Digital signatures are created using the sender's private key, and can be verified with the sender's public key. Successfully verifying a digital signature proves that the sender of the message is the holder of the corresponding private key. In other words, if Alice signs a message with her private key, and Bob verifies the signature with Alice's public key, Bob can be confident that Alice was the sender of the message, assuming that her key was not stolen (private keys should therefore be kept secure).

A digital signature is created for some message M using a hash function H, and the sender's public key Kpriv. To create the digital signature, the sender calculates H(M), and then encrypts H(M) with Kpriv. This encrypted piece of data is the digital signature.

To verify Alice's digital signature, Bob (the message recipient) can decrypt the signature with Alice's public key Kpub, which will produce H(M). The recipient can then compute the hash of the message that they received, H(M′). If H(M), the hash decrypted from the message signature, matches H(M′), the hash that Bob calculated from the message that he received, then Bob can be confident both that Alice was the sender of the message (authentication), and that the contents of the message were unchanged by any third party (integrity). If on the other hand H(M) does not match H(M′), Bob can infer that either Alice was not the sender of M, or that the message was altered by a third party and should be discarded.

Ethereum uses the SECP256k1 elliptic curve for its public/private key cryptography, and digital signatures are generated using ECDSA, the Elliptic Curve Digital Signature Algorithm. Ethereum also uses the Keccak256 hash function. A variety of signature functions and hash functions may be used in other implementations.

Transferring funds is a common type of transaction on blockchains 401, although it is not the only type. Most blockchain transactions are similar to Ethereum transactions, each of which includes the following data: the Ethereum address of the recipient; the amount of ETH to transfer; the maximum gas fee that the sender is willing to pay for the transaction; and a digital signature of the contract, which identifies the sender and protects the data from modification.

Someone who wishes to send a transaction builds the transaction which contains all of this data, and then generates and adds the digital signature before sending it to a node on the blockchain's network. Once the transaction is executed, the funds will be transferred from the sender to the recipient.

Each blockchain, whether it is Solana, Ethereum, Bitcoin, FLOW, or some other chain has what is called a block speed. The block speed is the rate at which the blockchain produces new blocks, which together form the public, distributed, immutable ledger of the blockchain. This ledger contains the updated balances of all the accounts on the blockchain's network since the last block. Once a transaction is executed, the transaction's results (i.e., account balances) are reflected in the next block that is added to the chain. At this point, the transaction is completed.

FIG. 5 is a block diagram of an example computer system 610 suitable for implementing a stacked tag processing system 101. Both mobile computing devices 103 and server computer systems 105 can be implemented in the form of such computer systems 610. As illustrated, one component of the computer system 610 is a bus 612. The bus 612 communicatively couples other components of the computer system 610, such as at least one processor 614, system memory 617 (e.g., random access memory (RAM), read-only memory (ROM), flash memory), an input/output (I/O) controller 618, an audio output interface 622 communicatively coupled to an audio output device such as a speaker 620, a display adapter 626 communicatively coupled to a video output device such as a display screen 624, one or more interfaces such as Universal Serial Bus (USB) receptacles 628, serial ports 630, parallel ports (not illustrated), etc., a keyboard controller 633 communicatively coupled to a keyboard 632, a storage interface 634 communicatively coupled to one or more hard disk(s) 644 (or other form(s) of storage media), a host bus adapter (HBA) interface card 635A configured to connect with a Fiber Channel (FC) network 690, an HBA interface card 635B configured to connect to a SCSI bus 639, an optical disk drive 640 configured to receive an optical disk 642, a mouse 646 (or other pointing device) coupled to the bus 612, e.g., via a USB receptacle 628, a modem 647 coupled to bus 612, e.g., via a serial port 630, and one or more wired and/or wireless network interface(s) 648 coupled, e.g., directly to bus 612.

Other components (not illustrated) may be connected in a similar manner (e.g., document scanners, digital cameras, printers, etc.). Conversely, all of the components illustrated in FIG. 5 need not be present (e.g., smartphones and tablets typically do not have optical disk drives 640, external keyboards 632 or external pointing devices 646, although various external components can be coupled to mobile computing devices via, e.g., USB receptacles 628). The various components can be interconnected in different ways from that shown in FIG. 5.

The bus 612 allows data communication between the processor 614 and system memory 617, which, as noted above may include ROM and/or flash memory as well as RAM. The RAM is typically the main memory into which the operating system 650 and application programs are loaded. The ROM and/or flash memory can contain, among other code, the Basic Input-Output system (BIOS) which controls certain basic hardware operations. Application programs can be stored on a local computer readable medium (e.g., hard disk 644, optical disk 642) and loaded into system memory 617 and executed by the processor 614. Application programs can also be loaded into system memory 617 from a remote location (i.e., a remotely located computer system 610), for example via the network interface 648 or modem 647. In FIG. 5, the stacked tag processing system 101 is illustrated as residing in system memory 617.

The storage interface 634 is coupled to one or more hard disks 644 (and/or other standard storage media). The hard disk(s) 644 may be a part of computer system 610 or may be physically separate and accessed through other interface systems.

The network interface 648 and/or modem 647 can be directly or indirectly communicatively coupled to a network 107 such as the internet. Such coupling can be wired or wireless.

As will be understood by those familiar with the art, the subject matter described herein may be embodied in other specific forms without departing from the spirit or integral characteristics thereof. Likewise, the particular naming and division of the portions, modules, agents, managers, components, functions, procedures, actions, layers, features, attributes, methodologies, data structures and other aspects are not mandatory or significant, and the entities used that implement the subject matter described herein may have different names, divisions and/or formats. The foregoing description, for purpose of explanation, has been described with reference to specific implementations. However, the illustrative discussions above are not intended to be exhaustive or limiting to the precise forms disclosed. Many modifications and variations are possible in view of the above teachings. The implementations were chosen and described in order to best explain relevant principles and their practical applications, to thereby enable others skilled in the art to best utilize various implementations with or without various modifications as may be suited to the particular use contemplated.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic device, that manipulates and transforms data represented as physical (electronic) quantities within the computer system's registers and memories into other data similarly represented as physical quantities within the computer system memories or registers or other such information storage, transmission or display devices.

Finally, the structure, algorithms, and/or interfaces presented herein are not inherently tied to any particular computer or other apparatus. Various general-purpose systems may be used with programs in accordance with the teachings herein, or it may prove convenient to construct more specialized apparatus to perform the method blocks. The structure for a variety of these systems will appear from the description above. In addition, the specification is not described with reference to any particular programming language. It will be appreciated that a variety of programming languages may be used to implement the teachings of the specification as described herein.

Accordingly, the disclosure is intended to be illustrative, but not limiting. IN THE CLAIMS All pending claims are reproduced below.

1. (canceled)

2. A computer-implemented method for gleaning and utilizing information concerning a user from radio waves with different frequencies and ranges, the method comprising:
associating a Near Filed Communication (“NFC”) tag, an RFID (“Radio Frequency Identification”) tag, and a stacked tag, the stacked tag comprising the NFC tag and the RFID tag in a single physical configuration, wherein the NFC tag has an identifier, the RFID tag has an identifier, and the stacked tag has an identifier;
maintaining, by a server computer, data concerning the stacked tag, the maintained data including at least the identifier of the stacked tag, the identifier of the NFC tag of the stacked tag, and the identifier of the RFID tag of the stacked tag;
receiving, by the server computer, a transmission from a mobile computing device operated by a user, in response to the NFC tag of the stacked tag having been scanned by the mobile computing device, the transmission including at least the identifier of the NFC tag of the stacked tag, the stacked tag being embedded in a portable item physically coupled to the user;
authenticating the NFC tag, by the server computer, in response to receiving the transmission from the mobile computing device;
adding an association between the user and the stacked tag to the maintained data concerning the stacked tag, by the server computer;
receiving, by the server computer, at least one transmission from at least one RFID tag reader in response to reading the RFID tag of the stacked tag by the at least one RFID tag reader, as the RFID tag of the stacked tag embedded in the portable item physically coupled to the user comes within read range of the at least one RFID tag reader; and
gleaning different granularities of information concerning the user from readings of the associated NFC tag of the stacked tag by the mobile computing device and of the RFID tag of the stacked tag by the at least one RFID tag reader.

3. The method of claim 2 further comprising:
presenting an interface to the user operating the mobile computing device, by the server computer, in response to the NFC tag of the stacked tag having been scanned by the mobile computing device operated by the user; and
prompting the user operating the mobile computing device to enter user data through the interface, by the server computer.

4. The method of claim 3 further comprising:
scanning of the NFC tag by the mobile computing device generating a Uniform Resource Locator (URL) pointing to the interface presented to the user by the server computer.

5. The method of claim 3 further comprising:
receiving user data entered by the user into the interface.

6. The method of claim 3 further comprising:
prompting the user to take and upload a selfie with the mobile computing device; and
gleaning information concerning the user from the selfie.

7. The method of claim 2 further comprising:
gleaning, by the server computer, information concerning the mobile computing device operated by the user, in response to the NFC tag of the stacked tag having been scanned by the mobile computing device.

8. The method of claim 2 wherein authenticating, by the server computer, the NFC tag in response to receiving the transmission from the mobile computing device further comprises:
determining, by the server computer, that the NFC tag is not already associated with this or any other user.

9. The method of claim 2 wherein authenticating, by the server computer, the NFC tag in response to receiving the transmission from the mobile computing device further comprises:
determining, by the server computer, that a URL generated by the NFC tag has not been previously utilized by this or any other user.

10. The method of claim 2 wherein authenticating, by the server computer, the NFC tag in response to receiving the transmission from the mobile computing device further comprises:
determining, by the server computer, that the NFC tag is a real NFC tag that is part of the stacked tag.

11. The method of claim 2 further comprising:
adding, to the maintained data concerning the stacked tag, information concerning the user gleaned from the mobile computing device operated by the user scanning the NFC tag of the stacked tag.

12. The method of claim 2 further comprising:
adding, to the maintained data concerning the stacked tag, information concerning the mobile computing device operated by the user.

13. The method of claim 2 further comprising:
adding, to the maintained data concerning the stacked tag, information concerning the user, entered by the user into an interface provided in response to the mobile computing device operated by the user scanning the NFC tag of the stacked tag.

14. The method of claim 2 wherein associating the stacked tag and the associated NFC tag and RFID tag with the user further comprises:
maintaining data concerning a plurality of stacked tags, the maintained data concerning each given stacked tag of the plurality including at least an identifier of the given stacked tag, and separate identifiers of a given RFID tag and of a given NFC tag of the given stacked tag;
identifying the stacked tag that contains the NFC tag scanned by the mobile computing device, in the maintained data concerning the plurality of stacked tags, by utilizing the identifier of the scanned NFC tag, by the server computer; and
adding an association between the user operating the mobile computing device with the identified stacked tag that contains the scanned NFC tag to the maintained data concerning the stacked tag, by the server computer.

15. The method of claim 2 wherein receiving, by the server computer, at least one transmission from at least one RFID tag reader in response to reading the RFID tag of the stacked tag by the at least one RFID tag reader, further comprises:
receiving, by the server computer, multiple transmissions including the identifier of the RFID tag from multiple RFID tag readers, each one of the multiple received transmissions being in response to a given one of the multiple RFID tag readers reading the RFID tag of the stacked tag, as the RFID tag of the stacked tag embedded in the portable item which is physically coupled to the user comes within a read range of the given one of the multiple RFID tag readers;
gleaning information concerning the user from the multiple received transmissions from multiple RFID tag readers; and
adding, to the maintained data concerning the stacked tag, information concerning the user gleaned from the multiple received transmissions from multiple RFID tag readers.

16. The method of claim 15 wherein:
the multiple RFID tag readers are located at different physical locations.

17. The method of claim 15 wherein:
the multiple RFID tag readers have different read ranges.

18. The method of claim 15 further comprising:
gleaning information concerning a physical location of the user from at least one received transmission including the identifier of the RFID tag.

19. The method of claim 15 further comprising:
gleaning information concerning movement of the user from multiple ones of the received transmissions including the identifier of the RFID tag.

20. The method of claim 15 further comprising:
gleaning information concerning interactions of the user with at least one external entity, from multiple ones of the received transmissions including the identifier of the RFID tag.

21. The method of claim 15 wherein associating the stacked tag and the associated NFC tag and RFID tag with the user further comprises:
maintaining data concerning a plurality of stacked tags, the maintained data concerning each given stacked tag of the plurality including at least an identifier of the given stacked tag, and separate identifiers of a given RFID tag and of a given NFC tag of the given stacked tag;
identifying the stacked tag which contains the read RFID tag, in the maintained data concerning the plurality of stacked tags, by utilizing the identifier of the read RFID tag, by the server computer; and
adding information gleaned from reading the RFID tag to the maintained data concerning the stacked tag.

22. The method of claim 2 wherein the stacked tag further comprises:
an NFC tag programmed to return a followable URL in response to being scanned.

23. The method of claim 2 wherein the stacked tag further comprises:
a tamper circuit configured to trip in response to a tampering with the stacked tag.

24. The method of claim 2 wherein the stacked tag further comprises:
a tamper circuit configured to trip in response to a tampering with the portable item in which the stacked tag is embedded.

25. The method of claim 2 further comprising:
taking a specific action directed at the user of the mobile computing device in response to different granularities of information concerning the user gleaned from readings of the associated NFC tag of the stacked tag by the mobile computing device and of the RFID tag of the stacked tag by the at least one RFID tag reader.

26. At least one non-transitory computer-readable storage medium for gleaning and utilizing information concerning a user from radio waves with different frequencies and ranges, the at least one non-transitory computer-readable storage medium storing computer executable instructions that, when loaded into computer memory and executed by at least one processor of a computing device, cause the computing device to perform the following steps:
associating a Near Filed Communication (“NFC”) tag, an RFID (“Radio Frequency Identification”) tag, and a stacked tag, the stacked tag comprising the NFC tag and the RFID tag in a single physical configuration, wherein the NFC tag has an identifier, the RFID tag has an identifier, and the stacked tag has an identifier;
maintaining data concerning the stacked tag, the maintained data including at least the identifier of the stacked tag, the identifier of the NFC tag of the stacked tag, and the identifier of the RFID tag of the stacked tag;
receiving a transmission from a mobile computing device operated by a user, in response to the NFC tag of the stacked tag having been scanned by the mobile computing device, the transmission including at least the identifier of the NFC tag of the stacked tag, the stacked tag being embedded in a portable item physically coupled to the user;
authenticating the NFC tag in response to receiving the transmission from the mobile computing device;
adding an association between the user and the stacked tag to the maintained data concerning the stacked tag;
receiving at least one transmission from at least one RFID tag reader in response to reading the RFID tag of the stacked tag by the at least one RFID tag reader, as the RFID tag of the stacked tag embedded in the portable item physically coupled to the user comes within read range of the at least one RFID tag reader; and
gleaning different granularities of information concerning the user from readings of the associated NFC tag of the stacked tag by the mobile computing device and of the RFID tag of the stacked tag by the at least one RFID tag reader.

27. A computer system for gleaning and utilizing information concerning a user from radio waves with different frequencies and ranges, the computer system comprising:
at least one processor;
a network interface, communicatively coupled to the at least one processor and to an external data communication network;
memory, communicatively coupled to the at least one processor;
a tag associating module residing in the memory and being configured to associate a Near Filed Communication (“NFC”) tag, an RFID (“Radio Frequency Identification”) tag, and a stacked tag, the stacked tag comprising the NFC tag and the RFID tag in a single physical configuration, wherein the NFC tag has an identifier, the RFID tag has an identifier, and the stacked tag has an identifier;
a data maintaining module residing in the memory and being configured to maintain data concerning the stacked tag, the maintained data including at least the identifier of the stacked tag, the identifier of the NFC tag of the stacked tag, and the identifier of the RFID tag of the stacked tag;
a receiving module residing in the memory and being configured to receive a transmission from a mobile computing device operated by a user, in response to the NFC tag of the stacked tag having been scanned by the mobile computing device, the transmission including at least the identifier of the NFC tag of the stacked tag, the stacked tag being embedded in a portable item physically coupled to the user;
the receiving module residing being further configured to receive at least one transmission from at least one RFID tag reader in response to reading the RFID tag of the stacked tag by the at least one RFID tag reader, as the RFID tag of the stacked tag embedded in the portable item physically coupled to the user comes within read range of the at least one RFID tag reader;
an authenticating module residing in the memory and being configured to authenticate the NFC tag in response to receiving the transmission from the mobile computing device;
an association adding module residing in the memory and being configured to add an association between the user and the stacked tag to the maintained data concerning the stacked tag; and
a gleaning module residing in the memory and being configured to glean different granularities of information concerning the user from readings of the associated NFC tag of the stacked tag by the mobile computing device and of the RFID tag of the stacked tag by the at least one RFID tag reader.
